(19) United States
(12) Patent Application Publication
(10) Pub. No.: US 2025/0116250 A1
(43) Pub. Date: Apr. 10, 2025

(54) FUEL PUMP

(71) Applicant: PHINIA DELPHI LUXEMBOURG SARL, Belvaux (LU)

(72) Inventors: Thibaud GUERET, Blois (FR); Laurent VINCENT, Saint Sulpice de Pommeray (FR)

(21) Appl. No.: 18/865,918

(22) PCT Filed: May 12, 2023
(86) PCT No.: PCT/EP2023/062713

§ 371 Date: Nov. 14, 2024

(30) Foreign Application Priority Data
May 16, 2022 (GB) 2207150.0

(51) Int. Cl. F02M 59/46; F02M 59/48; F02M 63/00

(52) U.S. Cl. CPC F02M 59/462; F02M 59/485; F02M 63/005

(57) ABSTRACT

A fuel pump comprising:
a pumping chamber with a pumping plunger arranged to reciprocate within the pumping chamber;
an inlet passage at least indirectly connecting a low-pressure inlet of the fuel pump to the pumping chamber, an inlet valve being adapted to selectively enable flow through the inlet passage to the pumping chamber;
an outlet passage at least indirectly connecting the pumping chamber to a high-pressure outlet of the fuel pump, an outlet valve being adapted to selectively enable flow through the outlet passage to the outlet; and
a relief passage connecting the outlet passage, downstream of the outlet valve, to the pumping chamber, a relief valve being adapted to selectively enable flow through the relief passage to the pumping chamber.

### FIELD OF THE INVENTION

The present invention relates to a fuel pump and to an outlet module for a fuel pump.

### BACKGROUND OF THE INVENTION

Fuel systems in modern internal combustion engines fueled by gasoline, particularly for use in the automotive market, mostly employ gasoline direct injection (GDi). In these systems, fuel injectors inject fuel directly into combustion chambers of the internal combustion engine. Commonly, fuel from a fuel tank is supplied under relatively low pressure by a low-pressure fuel pump which is typically an electric fuel pump located within the fuel tank. The low-pressure fuel pump supplies the fuel to a high-pressure fuel pump (also referred to as GDi pump), which typically includes a pumping plunger which is reciprocated by a camshaft of the internal combustion engine. During an intake stroke, fuel is sucked into the pumping chamber, and in a subsequent pumping stroke, the pumping plunger further pressurizes the fuel so that it can be supplied at high pressure to the fuel injectors.

For safe operation, the GDi pump includes a relief passage with an embedded relief valve to avoid any overpressure that could burst the pump or any part of the high-pressure system behind the pump (fuel rail, pipes and/or injectors) as well as limiting the pressure so that the pressure never reaches the injector Maximum Opening Pressure (MOP). In order to avoid backflow from the fuel rail into the pumping chamber, the fuel pump also comprises an outlet valve, which is disposed in an outlet passage on a high-pressure side of the pumping chamber. Integration of these valves into the fuel pump often leads to a complex design, and the various passages may weaken the overall structure of the fuel pump body. Another problem is that the design of relief valves and/or outlet valves in the art oftentimes only allows for checking the proper functionality late in the assembly process, when a single faulty part means that a major part of the fuel pump has to be scrapped.

### OBJECT OF THE INVENTION

The object of the present invention is to improve the design of a fuel pump with an integrated relief valve.

This object is achieved by a fuel pump according to claim 1.

### SUMMARY OF THE INVENTION

The present invention relates to a fuel pump. More specifically, it relates to a fuel pump for a combustion engine, in particular for a motor vehicle like a car. The fuel pump may be configured as a high-pressure pump, which receives fuel from a fuel tank via a low-pressure pump. The high-pressure pump then increases the pressure of the fuel, normally to at least 100 bar, sometimes up to 600 bar or even higher.

The fuel pump comprises a pumping chamber with a pumping plunger arranged to reciprocate within the pumping chamber. By the action of the pumping plunger, fuel can be sucked into the pumping chamber during an intake stroke and can subsequently be pressurized and expelled from the pumping chamber during a compression stroke or pumping stroke. Accordingly, the fuel enters the pumping chamber at a low pressure and exits the pumping chamber at a high pressure. The pumping plunger can be operated electrically, or it may be mechanically linked to an engine, in particular to the combustion engine that the fuel pump supplies with fuel. E.g., the pumping plunger can be linked to a camshaft of the engine. Since the plunger reciprocates (i.e., moves back and forth) along a straight line, at least a portion of the pump chamber is cylindrical with a cross-section corresponding to that of the plunger. However, the pumping chamber may comprise at least one portion that is not accessible by the plunger and that may have a non-cylindrical shape. It is understood that the pumping chamber, as well as the passages mentioned hereinafter, are defined inside a housing of the fuel pump.

The fuel pump further comprises an inlet passage at least indirectly connecting a low-pressure inlet of the fuel pump to the pumping chamber, an inlet valve being adapted to selectively enable flow through the inlet passage to the pumping chamber. The low-pressure inlet is adapted for connection to a low-pressure fuel source, normally a low-pressure pump. Instead of “low-pressure inlet” this could simply be referred to as an “inlet”, while the term “low-pressure” indicates that the fuel entering the inlet has not yet been pressurized by the fuel pump. Of course, the connection to the fuel source can be indirect, e.g., via a pipe, a hose, or the like. The inlet passage establishes a fluid connection, or fluid communication, between the inlet and the pumping chamber, either directly or indirectly. In case of an indirect connection, the inlet passage is connected to another passage that is connected to the inlet. During an intake stroke of the plunger, fuel is sucked through the inlet passage into the pumping chamber. The term “passage” here and in the following refers to any volume that is suitable for containing fuel and allowing transfer of the fuel from an origin (in this case, the low-pressure inlet) to a destination (in this case, the pumping chamber). Such a passage may have various shapes, e.g., straight, curved and/or angled, and may be branched or unbranched. The inlet valve is adapted to selectively enable flow through the inlet passage to the pumping chamber. Advantageously, the inlet valve is a normally open valve, which can be selectively actuated into the closed position, in order to prevent fuel from flowing in the opposite direction, i.e., back towards the inlet passage. In other words, the pressure on an inlet side of the inlet valve is to be greater than the pressure on a pumping-chamber side by at least the specified opening pressure. Additionally, the opening of the inlet valve may be assisted/controlled by an actuator. The inlet valve can be disposed on or inside the inlet passage, for example close to the inlet, close to the pumping chamber or somewhere in between. In order to minimize the pumping dead volume, it is highly preferred that the inlet valve is disposed close to the pumping chamber.

Furthermore, the fuel pump comprises an outlet passage at least indirectly connecting the pumping chamber to a high-pressure outlet of the fuel pump, an outlet valve being adapted to selectively enable flow through the outlet passage towards the outlet. The outlet passage is connected to the pumping chamber and is either directly or indirectly connected to the high-pressure outlet. Instead of “high-pressure outlet” this could simply be referred to as an “outlet”, while the term “high-pressure” indicates that the fuel exiting the outlet has been pressurized by the fuel pump. In assembled state, the outlet may be connected to a fuel rail which in turn is connected to a plurality of fuel injectors. During a pumping stroke, fuel is pressurized in the pumping chamber and then expelled from the pumping chamber through the outlet passage. The outlet valve is adapted to selectively enable flow through the outlet passage towards the pumping chamber. The outlet valve is normally a one-way valve (check-valve type) that prevents fuel from flowing in the opposite direction, i.e., towards the pumping chamber. Also, the outlet valve may only enable flow towards the outlet if a certain opening pressure is exceeded. The outlet valve can be disposed inside the outlet passage, for example close to the outlet, close to the pumping chamber or somewhere in between. In order to minimize the pumping dead volume, it is highly preferred that the outlet valve is disposed close to the pumping chamber.

Also, the fuel pump comprises a relief passage connecting the outlet passage, downstream of the outlet valve, to the pumping chamber, a relief valve being adapted to selectively enable flow through the relief passage to the pumping chamber. The relief passage originates from the outlet passage downstream of the outlet valve, and leads to the pumping chamber. Accordingly, fuel can be released from the outlet passage into the pumping chamber through the relief passage. The function of the relief passage is to prevent excessive overpressure in the outlet passage and/or for example a fuel rail connected to the outlet passage. The relief valve is adapted to selectively enable flow through the relief passage towards the pumping chamber. More specifically, the relief valve is a one-way valve that prevents fuel from flowing in the opposite direction, i.e., towards the outlet passage. Also, the relief valve only enables fuel flow towards the pumping chamber if a certain opening pressure is exceeded. In other words, if the pressure difference between the outlet passage and the pumping chamber is high enough, the relief valve opens to release fuel from the outlet passage through the relief passage. The relief valve can be disposed inside the relief passage, for example close to the outlet passage, close to the pumping chamber or somewhere in between.

According to the invention, the fuel pump comprises a main body and an outlet module. The main body defines the inlet passage, the pumping chamber and a receptacle, which is open towards a distal side and which extends into the main body along an outlet axis towards a proximal side so that the receptacle communicates with the pumping chamber. The inlet passage, the pumping chamber and the receptacle are volumes or spaces delimited by the main body. The main body, which is normally at least partially made of metal to provide the necessary pressure resistance and stability, is advantageously made of a single piece. The inlet valve can be received inside the main body or can be regarded as a part of the main body. Apart from the inlet passage and the pumping chamber, the main body defines the above-mentioned receptacle, which is a recess inside the main body. More specifically, it is an open recess, i.e. it is open towards a distal side (the main body having a receptacle opening at this distal side). The receptacle extends into the main body along an outlet axis the towards a proximal side, which is opposite the first side with respect to the outlet axis. More specifically, it extends into the main body so that it communicates with the pumping chamber. In other words, the pumping chamber and the receptacle are directly or indirectly connected.

The outlet module comprises an outlet-module body in which the outlet valve and the relief valve are received and which defines the outlet passage and the relief passage (or at least part thereof), the outlet-module body being at least partially received in the receptacle and connected to the main body in a fuel-tight manner. The outlet passage and the relief passage are defined or delimited by the outlet-module body, i.e., they are disposed inside the outlet-module body. The outlet valve and the relief valve are received in the outlet-module body, i.e., they are disposed inside the outlet-module body. In other words, the outlet passage, the relief passage and the corresponding valve mechanisms are combined inside the outlet-module body of the outlet module. The outlet-module body, in turn, is fully or at least partially received in the receptacle. It is understood that the design of the outlet-module body and its position inside the receptacle are adapted so that the outlet passage and the relief passage can communicate with the pumping chamber as described above. In order to prevent any fuel leakage through the receptacle, the outlet-module body is connected to the main body in a fuel-tight manner.

The inventive design allows for an integration of the outlet and pressure relief functions in a single outlet module that can be produced and assembled separately from the main body. It is possible to test the proper functions of the outlet module, in particular the functions of the outlet valve and the relief valve, before the outlet-module body is inserted into the receptacle. Accordingly, production errors or assembly errors can be identified before the final assembly of the fuel pump, which greatly helps to reduce scrap. In the worst case, only a faulty outlet module has to be replaced. In certain embodiments, it may even be possible to replace only part of the outlet module, thereby further reducing scrap. Also, integration of the relief passage into the outlet module decreases the need for machining operations on the main body. In fuel pumps known in the art, the relief passage often represents a structural weak point of the main body. This weak point is removed by the inventive design. Integration of the relief passage into the outlet-module body often allows for a design that does not weaken the structure of the outlet-module body in a comparable way.

According to a preferred design, the outlet-module body comprises an outer threading engaging an inner threading of the main body inside the receptacle, the inner and outer threading being concentrically disposed around the outlet axis. During assembly, the outlet-module body is screwed into the receptacle as the inner threading and outer threading engage. Since these threadings are concentric with respect to the outlet axis, a considerable axial force (in the direction of the outlet axis) can be exerted between the main body and the outlet-module body. This axial force can be used to provide a fuel-tight seal between the main body of the outlet-module body. The screw connection is favorable e.g., compared to a welding connection, which could induce thermal stress and lead to distortion of the main body and/or the outlet-module body.

Specifically, the outlet-module body may comprise a first sealing portion that engages a second sealing portion of the main body inside the receptacle. Preferably, at least one sealing portion comprises an annular knife-edge element that cuts into the other sealing portion to create a knife-edge seal. In this embodiment, the outlet-module body and the main body comprise corresponding sealing portions which directly engage each other to provide the fuel-tight seal. One of the sealing portions comprises an annular knife-edge element, which usually has a pointed, wedge-like or blade-like profile. The knife-edge element is annular and concentric about the outlet axis. By the screwing action between the first and second threading, the knife-edge element on one sealing portion is rotated about the outlet axis with respect to the other sealing portion while it is also pressed axially against the other sealing portion. The hardness of the knife-edge element is sufficient so that it cuts into the other sealing portion, thereby providing a knife-edge seal. This kind of seal is known to be extremely reliable and resistant to high pressure.

The outlet-module body is made of a single piece. In other words, a single piece (of metal) is used for the outlet-module body, which normally undergoes various machining operations, e.g., for providing the outlet passage and the relief passage, the outer thread (if present) or other features. However, at least some features of the outlet-module body can be defined by an initial casting process. The single-piece design facilitates assembly of the outlet module and increases the structural stability of the outlet-module body.

The assembly process is further facilitated if the outlet-module body comprises a distal insertion opening on the distal side, through which the relief valve is inserted into the outlet-module body during assembly. The distal insertion opening is designed to allow for the relief valve to be inserted into the outlet-module body. It is disposed on the distal side, which means that the relief valve is moved towards the proximal side as it is inserted. If, as is usually the case, the relief valve comprises several components, these can be pre-assembled outside of the outlet-module body before the entire relief valve is inserted. Optionally, this may allow for the relief valve to be tested before it is inserted into the outlet-module body. It may also help to identify production or assembly errors in the relief valve at an early stage so that it is possible to discard a faulty relief valve and replace it with an intact one instead of having to scrap the entire outlet module. In some embodiments, the distal insertion opening is the (high-pressure) outlet of the fuel pump.

Preferably, the relief valve comprises a first seat member, a first valve member and a first spring member for biasing the first valve member against the first seat member, the first seat member being press-fitted into the outlet-module body. The first valve member and the first seat member cooperate to provide the valve mechanism, wherein the first seat member represents the stationary part of the relief valve and the first valve member represents the movable part. The first spring member acts directly or indirectly between the first seat member and the first valve member. By the action of the first spring member, the first valve member is biased against the first seat member into a closed position of the relief valve. Accordingly, a force acting on the first valve member due to a pressure difference has to overcome the force of the first spring member to move the first valve member into an open position, thereby opening the relief valve. The first seat element is press-fitted into the outlet-module body, thereby providing a fluid-tight connection while at the same time avoiding e.g., a welding operation which could lead to distortion or thermal stress.

One embodiment provides that the first seat member comprises a through-bore extending from a pump side, which is in communication with the pump chamber, to an outlet side, which is in communication with the outlet passage, the first valve element having a head for engaging the first seat member from the pump side in a closed position of the relief valve and an elongate shaft traversing the through-bore, the first spring element being disposed on the outlet side and engaging a stop member rigidly connected to the shaft. The pump side of the seat member is the side that is in communication with the pump chamber and thus is subjected to the changing pressure of the pump chamber. The outlet side is in communication with the outlet channel and is thus subjected to the pressure in the outlet channel. The outlet side may also be referred to as a high-pressure side. The first valve member comprises at least a head and a shaft, wherein the shaft passes through the through-bore of the first seat element from the pump side to the outlet side, while the head is too large to pass through the through-bore. Instead, the head engages an annular seat surrounding the through-bore. The overall shape of the first valve member may be compared to a needle. The shaft is elongate and has a length that normally corresponds to at least 5 times, 10 times or 15 times its (maximum) thickness. The thickness of the shaft may be constant or may change along its length. The head, on the other hand, is a portion of the valve element that is wider than the shaft. The first spring element engages a stop element that is rigidly connected to the shaft, preferably in proximity of an outlet-side end of the shaft. Either way, the first spring element is disposed on the outlet side, which is also true for a major part of the shaft. Accordingly, a major part of the relief valve is disposed on the outlet side. This is advantageous in that the size of the relief valve can be increased (e.g. to provide for a stronger and bigger first spring element) without increasing the pumping dead volume. Also, since the first spring element is preloaded by the stop member, it is possible to verify (and possibly adjust) the preload of the first spring element before the relief valve is inserted into the outlet-module body.

Preferably, the stop member is press-fitted onto the shaft. This allows for an easy calibration of the relief valve. The opening pressure of the relief valve depends, among other factors, on the pre-stress of the first spring element, which can be calibrated by adjusting the position of the stop member. In this embodiment, the stop member is produced separately from the shaft and is positioned onto the shaft according to a desired opening pressure. Proper function can be tested before the outlet module is inserted into the receptacle and—in preferred embodiments—even before the relief valve is inserted into the outlet-module body.

The relief valve may comprise a guide sleeve fitted over the shaft and surrounded by the first spring element, the guide sleeve extending from the the first seat member towards the stop member. Normally, the guide sleeve is firmly connected to the first seat member. Its overall shape is normally elongate and it may extend along a substantial portion of the shaft, e.g. at least 50 or at least 70%. The guide sleeve is interposed between the shaft and the first spring element (which is normally a coil spring), thereby guiding the movement of the first valve element and preventing any interference between the shaft and the first spring element. Optionally, the guide sleeve may also be an abutment member for the stop member, i.e., it may limit the movement of the stop member (and the first valve element) when the stop member abuts the guide sleeve.

The assembly process is further facilitated if the outlet-module body comprises a proximal insertion opening on the proximal side, through which the outlet valve is inserted into the outlet-module body during assembly. The proximal insertion opening is designed to allow for the outlet valve to be inserted into the outlet-module body. It is disposed on the proximal side, which means that the outlet valve is moved towards the distal side as it is inserted. Depending on the design, individual components of the outlet valve can be pre-assembled outside of the outlet-module body, or they may be inserted one after another. The first option may allow for the outlet valve to be tested before it is inserted into the outlet-module body.

Preferably, the outlet valve comprises a second seat member, a second valve member and a second spring member for biasing the second valve member against the second seat member, the second seat member being press-fitted into the outlet-module body. Again, the second seat member represents the stationary part of the outlet valve, and the second valve member represents the movable part. The second spring member acts directly or indirectly between the second seat member and the second valve member, thereby biasing the second valve member against the second seat member into a closed position of the outlet valve. Accordingly, a force acting on the second valve member according to a pressure difference has to overcome the force of the second spring member to move the second valve member into an open position, thereby opening the outlet valve. The second seat element is press-fitted into the outlet-module body, thereby providing a fluid-tight connection while at the same time avoiding e.g. a welding operation which could lead to distortion or thermal stress.

In this context, it is possible that the press fit is enough to provide a reliable connection between the second seat member and the outlet-module body. In some cases, the connection may further be improved. According to one such embodiment, a rim portion of the outlet-module body around the second opening is crimped to form-fittingly retain the second seat member inside the outlet-module body. The corresponding crimping operation reduces the diameter of the second opening so that the second seat element, regardless of the press-fit, cannot be removed through the second opening.

One embodiment provides that the outlet passage comprises a proximal portion, in which the outlet valve is at least partially received, a distal portion, in which the relief valve is at least partially received, and a plurality of intermediate portions connecting the proximal portion and the distal portion, the outlet axis traversing the proximal portion and the distal portion and the intermediate portions being offset from the outlet axis. As a rule, the proximal portion is furthest away from the outside of the main body. The proximal portion may be disposed adjacent to the inlet passage. The outlet valve is at least partially received in the proximal portion. The distal portion is normally disposed furthest away from the inlet passage and either closest to the outlet or even comprises the outlet. The relief valve is at least partially received in the distal portion. The proximal portion and the distal portion are connected by a plurality of intermediate portions, e.g., between two and five, preferably three or four, intermediate portions. While the outlet axis traverses the proximal and distal portion, the intermediate portions are disposed offset from the outlet axis, one could say radially offset from the outlet axis. This may facilitate a compact design of the outlet module since the offset arrangement of the intermediate portions allows for other elements to be arranged near or on the outlet axis. It is even possible that the axial position of the proximal portion and/or the distal portion overlaps with the axial positions of the intermediate portions, with the intermediate portions being disposed radially outside of the proximal portion and/or the distal portion. According to one embodiment, the intermediate portions extend parallel to the outlet axis. This facilitates production of the outlet-module body, since the intermediate portions can e.g., be drilled by parallel drilling operations.

According to another embodiment, at least one of the outlet valve, the relief valve and the outlet passage is at least mostly symmetrical to the outlet axis. “At least mostly symmetrical” means that some (minor) parts may not be symmetrical, but the overall configuration is symmetrical. The symmetric design may facilitate the production as well as the assembly of the outlet module. Also, it may help to optimize the fuel flow through the outlet module. Regarding the relief valve, it is preferred that the first valve element, the first seat element and the first spring element each are symmetrical to the outlet axis. The same applies to the second valve element, the second seat element and the second spring element of the outlet valve. In this context, a coil spring is considered to be symmetrical to the outlet axis if its spring axis coincides with the outlet axis. If the outlet passage has a proximal portion, a distal portion and intermediate portions, the intermediate portions may be disposed on a circle concentric to the outlet axis and evenly spaced along the tangential direction.

The relief passage may comprise a main portion adjacent to the relief valve and a plurality of branch portions connected to the main portion, traversing the outlet-module body to an outside thereof, and communicating with the pump chamber. The main portion is normally disposed near the outlet axis and may be symmetric thereto. It is disposed adjacent to the relief valve and the relief valve is normally in direct communication with the main portion. The branch portions diverge/split off from the main portion and constitute individual connections between the main portion and the outside of the outlet-module body. They may be disposed symmetrical with respect to the outlet axis. The branch portions can be straight and can be produced by drilling. As a rule, they are not parallel to the outlet axis but are arranged at an angle thereto, e.g., an angle of at least 20° or at least 40°. They may even be arranged radially with respect to the outlet axis. In some embodiments, the axial positions of the branch portions may overlap with those of the intermediate portions. In this case, the different portions are tangentially offset from each other to avoid any interference.

The invention also relates to an outlet module for a fuel pump, which fuel pump comprises a main body defining
a pumping chamber with a pumping plunger arranged to reciprocate within the pumping chamber,
an inlet passage at least indirectly connecting a low-pressure inlet of the fuel pump to the pumping chamber, an inlet valve being adapted to selectively enable flow through the inlet passage to the pumping chamber, and
a receptacle, which is open towards a distal side and which extends into the main body along an outlet axis towards a proximal side so that the receptacle communicates with the pumping chamber.

According to the invention, the outlet module has an outlet-module body in which an outlet valve and a relief valve are received and which defines an outlet passage and a relief passage, the outlet-module body being adapted to be at least partially received in the receptacle and connected to the main body in a fuel-tight manner, so that
the outlet passage at least indirectly connects the pumping chamber to a high-pressure outlet of the fuel pump, the outlet valve being adapted to selectively enable flow through the outlet passage to the outlet; and
the relief passage connects the outlet passage, downstream of the outlet valve, to the pumping chamber, the relief valve being adapted to selectively enable flow through the relief passage to the pumping chamber;

All these terms have been explained above with respect to the inventive fuel pump and therefore will not be explained again. Preferred embodiments of the inventive outlet module correspond to those of the inventive fuel pump.

### BRIEF DESCRIPTION OF THE DRAWINGS

The present invention will now be described, by way of example, with reference to the accompanying drawings, in which:

FIG. 1: is a sectional view of an inventive fuel pump;

FIG. 2: is a sectional view of a detail of the fuel pump of FIG. 1; and

FIG. 3: is a perspective cutaway view of an outlet-module body of the fuel pump of FIG. 1.

### DETAILED DESCRIPTION OF PREFERRED EMBODIMENTS

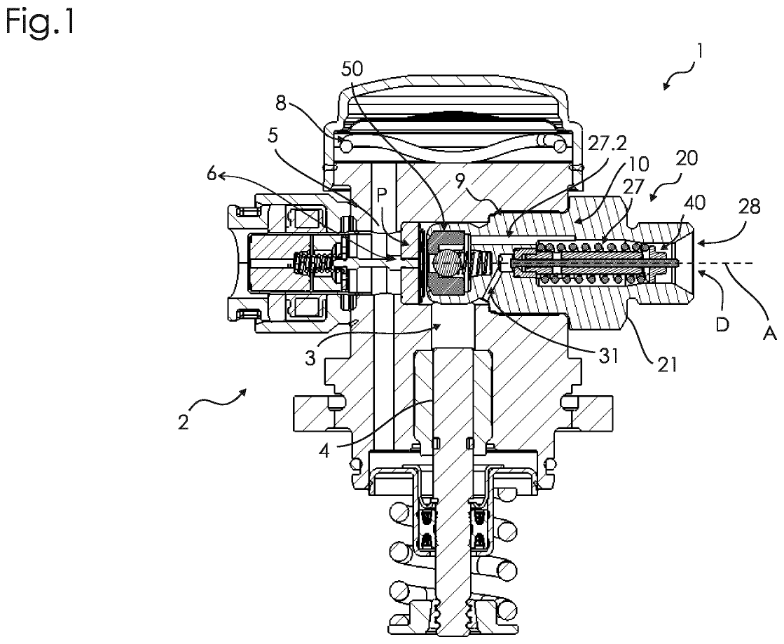

FIG. 1 shows a fuel pump 1 according to the present invention with an inventive outlet module 20. The general structure and operating principle of the fuel pump 1 are generally known and thus will only be briefly described here. Fuel pump 1 is typically part of a fuel system (not shown) of an internal combustion engine, which generally includes a fuel tank holding a volume of fuel to be supplied to the engine for operation thereof. A low-pressure fuel pump draws fuel from fuel tank and elevates the pressure of the fuel (e.g. up to 5 bar) for delivery to the (high-pressure) fuel pump 1 which in turn further elevates the pressure of the fuel (e.g. to between 10 bar an 50 bar) for delivery to the fuel injectors, which then directly inject the fuel into the combustion chambers of the cylinders of the engine.

The fuel pump 1 comprises a main body 2 with various parts, most of which are made of metal, e.g., stainless steel. The main body 2 defines a pumping chamber 3 with a pumping plunger 4, which is adapted to reciprocate within the pumping chamber and may be mechanically linked to a rotating camshaft (not shown) of the engine. The pumping chamber 3 is connected to an inlet passage 5 with an inlet valve 6. Conventionally, the inlet passage 5 is connected to a low-pressure inlet (not visible in the figures) of the fuel pump 1, via which the fuel pump 1 can be connected to the abovementioned low-pressure pump. Fuel enters the pump 1 via the low-pressure inlet, flows through a a damping volume 8, which is defined by a damper cup mounted to the main body 2, as is known in the art, and then enters the inlet passage 5. Although not shown in detail, the inlet valve 6 typically comprises a seat member defining one or more flow orifices that can be sealed by a flexible disk valve member that can be raised from the seat member by means of an actuating rod controlled by a solenoid actuator. This is only one conventional example of inlet valve and should not be construed as limiting.

The main body 2 also defines a receptacle 9 that is aligned along an outlet axis A and opens to an outside of the main body 2 at a receptacle opening 10. The receptacle opening 10 is disposed on a distal side D with respect to the outlet axis A, and the receptacle extends into the main body 2 towards a proximal side P so that it communicates with the pumping chamber 3. An inventive outlet module 20 is partially received in the receptacle 9. The outlet module 20 comprises an outlet-module body 21 that is made of a single piece of stainless steel. The outlet-module body 21 defines an outlet passage 27 connecting the pumping chamber 3 to a high-pressure outlet 28 of the fuel pump 1, and a relief passage 31 connecting the outlet passage 27 to the pumping chamber 3. A relief valve 40 and an outlet valve 50 are received inside the outlet-module body 21. The outlet valve 50 is a one-way valve that enables fuel flow from the pumping chamber 3 to the outlet 23 if the pressure on the pumping chamber 3 side exceeds a predefined outlet pressure (set by spring 53 and the pressure in 27.2). The relief valve 40 also is a one-way valve that enables flow from the outlet passage 27 through the relief passage 31 the pumping chamber 3 if the pressure in the outlet passage 27 exceeds the pressure in the pumping chamber 3 and the difference is greater than a defined relief opening pressure.

During operation, the reciprocating movement of the pumping plunger 4 causes fuel to be drawn from the inlet passage 5 into the pumping chamber 3 during an intake stroke. During a following pumping or compression stroke, the fuel in the pumping chamber 3 is pressurized and expelled through the outlet valve 50 and the outlet passage 27. The fuel can then be supplied via the outlet 28 to a fuel rail that is connected to the above-mentioned injectors. During the compression stroke, the inlet valve 6 is closed and prevents backflow through the inlet passage 5. If at any time the pressure in the outlet passage 22 exceeds the predefined relief opening pressure, the relief valve 40 opens to release fuel from the outlet passage 22 through the relief passage 30 into the pump chamber 3, thereby preventing possible damage to any components downstream of the fuel pump 1.

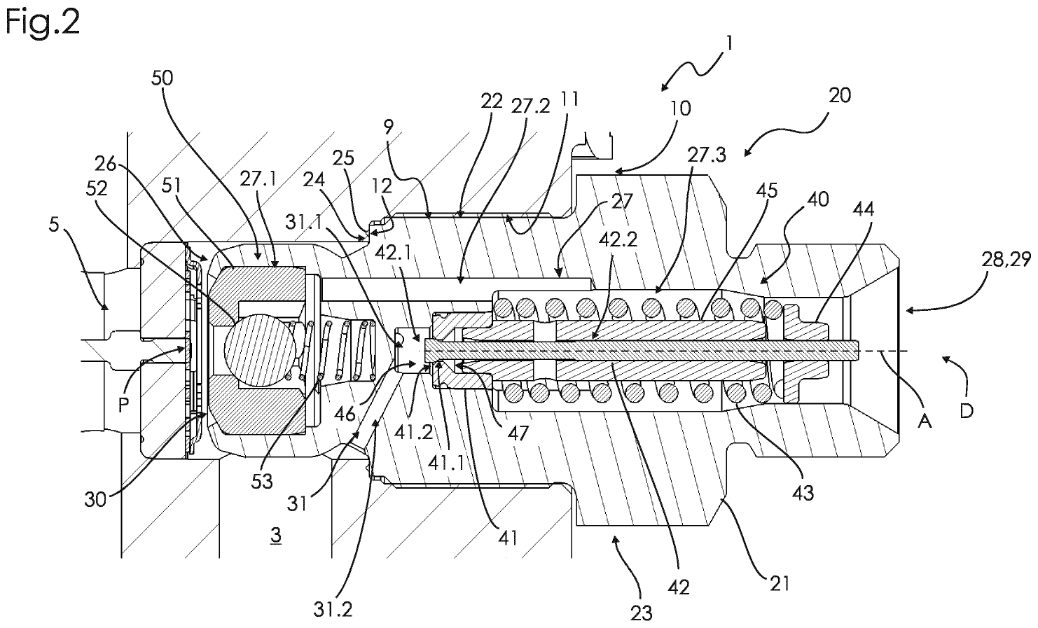

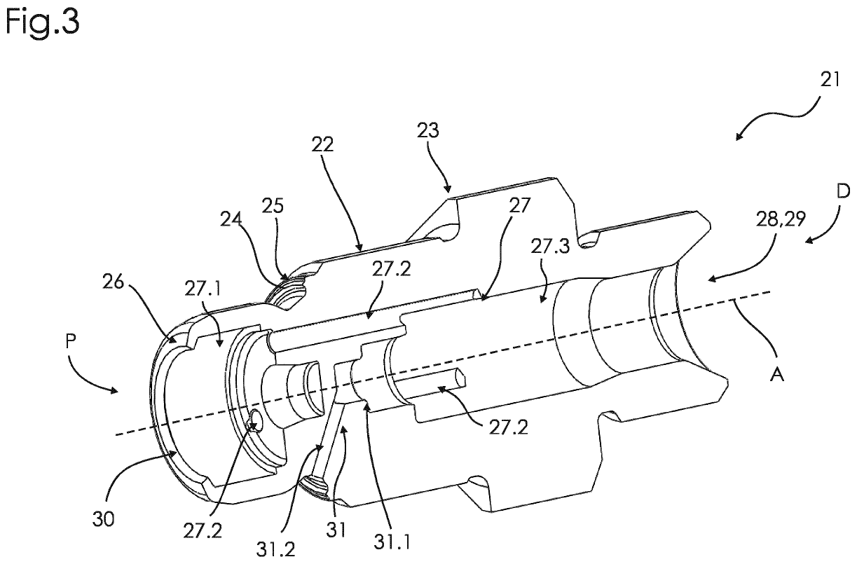

Details of the outlet module 20 will now be discussed with reference to FIGS. 2 and 3. The outlet-module body 21 is symmetrical with respect to the outlet axis A. It comprises an outer threading 22 that is concentric to the outlet axis A and engages a corresponding inner threading 11 on an inside of the receptacle 9. During assembly, the outlet-module body 21 is inserted through the receptacle opening 10 and is screwed into the receptacle 9 by the cooperation of the above-mentioned threading 11, 22. To facilitate screwing, the outlet-module body 21 comprises an outer hexagonal drive profile 23. At the end of the screwing process, a first sealing surface 24 of the outlet-module body 21 engages a second sealing surface 12 of the main body 2. Specifically, the first sealing surface 24 comprises an annular knife-edge element 25 that cuts into the second sealing surface 12 to provide a knife-edge seal. Accordingly, the outlet-module body 21 is connected to the main body 2 in a fuel-tight manner without the need for a welding operation that could lead to thermal stress and deformation.

The outlet passage 27 as well as the relief passage 31 are produced by machining operations performed on the outlet-module body 21, e.g., by drilling. Specifically, the outlet passage 27 comprises a proximal portion 27.1, in which the outlet valve 50 is received, and a distal portion 27.3, in which a major part of the relief valve 40 is received and which opens into the outlet 28. The proximal portion 27.1 and the outer portion 27.3 are symmetrical to the outlet axis A and are connected by three intermediate portions 27.2 that are parallel to the outlet axis A but radially offset therefrom. These intermediate portions 27.2 are tangentially offset by 120° with respect to each other. The relief passage 31 comprises a main portion 31.1 centrally disposed on the outlet axis A and three branch portions 31.2 that originate from the main portion 31.1 at an angle of e.g. 70° with respect to the outlet axis A. These branch portions 31.2 are also disposed symmetrical about the outlet axis A, wherefore they are tangentially offset by 120° respect to each other. Since the axial positions of the branch portions 31.2 overlap with those of the intermediate portions 27.2, they are tangentially offset so that one branch portion 31.2 is disposed between two intermediate portions 27.2, and vice versa. The radial offset of the intermediate portions 27.2 from the outlet axis A allows for parts of the relief valve 40 and the outlet valve 50 to be positioned close to the outlet axis A in axial positions that overlap with those of the intermediate portions 27.2. Also, the main portion 31.1 can be disposed close to the outlet axis A without interfering with the intermediate portions.

The relief valve 12 is mostly received in the distal portion 27.3 of the outlet passage 27, i.e., it is located downstream of outlet valve 50. It comprises a first seat member 41, a first valve element 42, a first spring element 43, a stop member 44 and a guide sleeve 45. The first seat member 41 is press-fitted into the outlet-module body 21 at a transition between the distal portion 27.3 and the main portion 31.1. The press-fit provides a metal-to-metal seal, preventing fuel flow around the seat member 41. A central through-bore 41.1 extends from a pump side 46 to an outlet side 47 of the seat member 41, one could also say from a proximal side P to a distal side D of the seat member 41. An annular seat 41.2 is provided on the pump side 46 and surrounds the through-bore 41.1. Seat member 41 comprises on the first distal side an enlarged bore section in axial continuation of through bore 41.1, in which the guide sleeve 45 is partly received, preferably press-fittingly.

The first valve element 42 comprises an elongate shaft 42.2 (extending parallel to the outlet axis A) and a radially protruding head 42.1 at a proximal end of the shaft 42.2. The shaft 42.2 extends through the through-bore 41.1, while the head 42.1, due to its larger diameter, cannot pass through the through-bore 41.1. In the closed position of the relief valve 40 shown in FIGS. 1 and 2, the head 42.1 engages the annular seat 41.2 from the pump side 46, which communicates with the pumping chamber 3 and is thus subjected to the pressure in the pumping chamber 3. Most of the shaft 42.2, the stop element 44, the first spring element 43 and the guide sleeve 45 are disposed on the outlet side 47 of the first seat element 41, i.e., in communication or within the outlet passage 27. Accordingly, most of the relief valve 40 is in a region that does not communicate with the pump chamber 3, as long as the relief valve 40 is closed, and thus is not part of the dead volume. This dead volume can be kept small even if the size of the relief valve 40 is increased.

In the figures, the first valve element 42 is shown in its closed position, in which the head 42.1 rests against the annular seat 41.2 due to the biasing force the first spring element 43. If the force acting on the first valve element 42 due to a pressure difference between the pump side 46 and the outlet side 47 overcomes the spring force, the first valve element 42 moves to the pump side 46 (i.e., proximally) and the relief valve 40 opens. The spring force in the closed position can be calibrated by adapting the position of the stop member 44 on the shaft 42.2. In this embodiment, stop member 44 is an annular piece with a central hole therein, which is dimensioned to be fixed onto the shaft 42.2 by press-fitting. The position of the stop member 44, which can be easily adjusted, determines the opening pressure of the relief valve 40. The guide sleeve 45 is fitted over the shaft 42.2 and press fitted into the first seat member 41. The guide sleeve 45 is provided to maintain the shaft 42.1, and the first valve element 42 as a whole, in axial alignment, in particular when the head 42.1 is lifted from seat 41.2. In order to allow for fluid communication and pressure exchange, a clearance is provided between the shaft 42.1 and the guide sleeve 45.

For assembly of the outlet module 20, the relief valve 40 can be preassembled before it is inserted into the outlet-module body 21 through a distal insertion opening 29, which in this embodiment is the outlet 28. It is maintained in the outlet-module body 21 by the press-fit of the first seat member 41. Accordingly, the relief valve 40 can be tested before it is inserted and the biasing force of the first spring member 43 can be calibrated by adapting the position of the stop member 44 on the shaft 42.2. A faulty relief valve 40 may thus be identified and replaced before it is inserted into the outlet-module body 21. In other words, it is normally unnecessary to discard the entire outlet module 20, which greatly reduces scrap. It is also possible to test the outlet module 20 before it is connected with the main body 2. If any production error is found at this stage, the outlet module 20 can be replaced without the need to discard the entire fuel pump.

The outlet valve 50 is received in the proximal portion 27.1. During assembly, it is inserted through a proximal insertion opening 30 on the proximal side P of the outlet-module body 21. More specifically, a second spring element 53, which is a coil spring, is inserted first, then a ball-shaped second valve element 52 is inserted, before finally a second seat element 51 is press-fitted into the proximal portion 27.1. Second seat element 51 has a cup shape and is provided with a flow orifice in its bottom. Second valve element 52 is at least partially received within the cup-shaped seat element 51 and moveable therein. In FIG. 2 the second valve element 52 is biased by spring 53 against the seat element 51, closing the orifice: the second valve 50 is closed. In order to provide a more stable connection, a rim portion 26 circumferentially disposed around the proximal insertion opening 30 is crimped to form-fittingly retain the outlet valve 50.

### LEGEND OF REFERENCE NUMBERS

1 fuel pump
2 main body
3 pumping chamber
4 pumping plunger
5 inlet passage
6 inlet valve
8 damping volume
9 receptacle
10 receptacle opening
11 inner threading
12 second sealing surface
20 outlet module
21 outlet-module body
22 outer threading
23 drive profile
24 first sealing surface
25 knife-edge element
26 rim portion
27 outlet passage
27.1 proximal portion
27.2 intermediate portion
27.3 distal portion
28 outlet
29 distal insertion opening
30 proximal insertion opening
31 relief passage
31.1 main portion
31.2 branch portion
40 relief valve
41 first seat element
41.1 through-bore
41.2 seat
42 first valve element
42.1 head
42.2 shaft
43 first spring element
44 stop element
45 guide sleeve
46 pump side
47 outlet side
50 outlet valve
51 second seat element
52 second valve element
53 second spring element
A outlet axis
D distal side
P proximal side

1. A fuel pump comprising:
a. a pumping chamber with a pumping plunger arranged to reciprocate within the pumping chamber;
b. an inlet passage at least indirectly connecting a low-pressure inlet of the fuel pump to the pumping chamber, an inlet valve being adapted to selectively enable flow through the inlet passage to the pumping chamber;
c. an outlet passage at least indirectly connecting the pumping chamber to a high-pressure outlet of the fuel pump, an outlet valve being adapted to selectively enable flow through the outlet passage to the outlet;
d. a relief passage connecting the outlet passage, downstream of the outlet valve, to the pumping chamber, a relief valve being adapted to selectively enable flow through the relief passage to the pumping chamber;
wherein the fuel pump comprises a main body defining the inlet passage, the pumping chamber and a receptacle, which is open towards a distal side and which extends into the main body along an outlet axis towards a proximal side so that the receptacle communicates with the pumping chamber;
wherein the fuel pump comprises an outlet module with an outlet-module body which is made of a single piece and in which the outlet valve and the relief valve are received and which defines the outlet passage and the relief passage, the outlet-module body being at least partially received in the receptacle and connected to the main body in a fuel-tight manner.

2. The fuel pump according to claim 1, wherein the outlet-module body comprises an outer threading engaging an inner threading of the main body inside the receptacle, the inner threading and outer threading being concentrically disposed around the outlet axis.

3. The fuel pump according to claim 2, wherein the outlet-module body comprises a first sealing portion that engages a second sealing portion of the main body inside the receptacle, wherein at least one sealing portion comprises an annular knife-edge element that cuts into the other sealing portion to create a knife-edge seal.

4. The fuel pump according to claim 1, wherein the outlet-module body comprises a distal insertion opening on the distal side, through which the relief valve is inserted into the outlet-module body during assembly.

5. The fuel pump according to claim 1, wherein the relief valve comprises a first seat member, a first valve member and a first spring member for biasing the first valve member against the first seat member, the first seat member being press-fitted into the outlet-module body.

6. The fuel pump according to claim 5, wherein the first seat member comprises a through-bore extending from a pump side, which is in communication with the pump chamber, to an outlet side, which is in communication with the outlet passage, the first valve element having a head for engaging the first seat member from the pump side in a closed position of the relief valve and an elongate shaft traversing the through-bore, the first spring element being disposed on the outlet side and engaging a stop member rigidly connected to the shaft.

7. The fuel pump according to claim 6, wherein the stop member is press-fitted onto the shaft.

8. The fuel pump according to claim 6, wherein the relief valve comprises a guide sleeve fitted over the shaft and surrounded by the first spring element, the guide sleeve extending from the first seat member towards the stop member.

9. The fuel pump according to claim 1, wherein the outlet-module body comprises a proximal insertion opening on the proximal side, through which the outlet valve is inserted into the outlet-module body during assembly.

10. The fuel pump according to claim 1, wherein the outlet valve comprises a second seat member, a second valve member and a second spring member for biasing the second valve member against the second seat member, the second seat member being press-fitted into the outlet-module body.

11. The fuel pump according to claim 1, wherein the outlet passage comprises a proximal portion, in which the outlet valve is at least partially received, a distal portion, in which the relief valve is at least partially received, and a plurality of intermediate portions connecting the proximal portion and the distal portion, the outlet axis traversing the proximal portion and the distal portion and the intermediate portions being offset from the outlet axis.

12. The fuel pump according to claim 1, wherein at least one of the outlet valve, the relief valve and the outlet passage is at least mostly symmetrical to the outlet axis.

13. The fuel pump according to claim 1, wherein the relief passage comprises a main portion adjacent to the relief valve and a plurality of branch portions connected to the main portion, traversing the outlet-module body to an outside thereof, and communicating with the pump chamber.

14. An outlet module for a fuel pump, which fuel pump comprises a main body defining
a. a pumping chamber with a pumping plunger arranged to reciprocate within the pumping chamber,
b. an inlet passage at least indirectly connecting a low-pressure inlet of the fuel pump to the pumping chamber, an inlet valve being adapted to selectively enable flow through the inlet passage to the pumping chamber, and
c. a receptacle which is open towards a distal side and which extends into the main body along an outlet axis towards a proximal side so that the receptacle communicates with the pumping chamber,
wherein
the outlet module has an outlet-module body which is made of a single piece and in which an outlet valve and a relief valve are received and which defines an outlet passage and a relief passage, the outlet-module body being adapted to be at least partially received in the receptacle and connected to the main body in a fuel-tight manner, so that
d. the outlet passage at least indirectly connects the pumping chamber to a high-pressure outlet of the fuel pump, the outlet valve being adapted to selectively enable flow through the outlet passage to the outlet; and
e. the relief passage connects the outlet passage, downstream of the outlet valve, to the pumping chamber, the relief valve being adapted to selectively enable flow through the relief passage to the pumping chamber.
